(19) United States
(12) Patent Application Publication
(10) Pub. No.: US 2008/0257838 A1
(43) Pub. Date: Oct. 23, 2008

(54) CARTRIDGE BASED FILTER ASSEMBLY FOR USE IN REMOVING SUB MICRONIC PARTICLES FROM FLUIDS

(76) Inventor: Gene Hirs, Waterford, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/043,715

(22) Filed: Mar. 6, 2008

Related U.S. Application Data
(63) Continuation-in-part of application No. 11/738,881, filed on Apr. 23, 2007, now abandoned.

(51) Int. Cl. B01D 15/10; B01D 27/08

(52) U.S. Cl. 210/807; 210/266

(57) ABSTRACT

A cartridge filter shaped as a dome with inlet and outlet. A plurality of horizontal filter cells are stacked and locked together during assembly and operate to remove submicron sized particulates, by passing the fluid through horizontal filtration cells composed of granular filter aids containing large filter areas.

### CROSS-REFERENCE TO RELATED APPLICATIONS

This application is a continuation-in-part of U.S. patent application Ser. No. 11/738,881 filed Apr. 23, 2007.

### FIELD OF THE INVENTION

The present invention relates generally to cartridge filter assemblies for filtering liquids. More specifically, the present invention teaches a cartridge filter assembly for removing submicron sized particulates, by passing the fluid through horizontal filtration cells composed of granular filter aids containing large filter areas.

### BACKGROUND OF THE INVENTION

Most cartridge filters are typically constructed of pleated paper at the periphery of a vertical cylinder. Other vertical cartridge filters are made to cover a cylinder with paper or fiber materials such as mesh or felt. The two-dimensional filter areas of these filters is relatively low. The same area restriction is in U.S. Pat. No. 3,443,697 to Seggeruch establishing a plurality of cup shaped plates vertically stacked and using a paper or fabric media. This type of filter is generally a large filter that has to be disassembled to remove accumulated contaminants. None of the mentioned filters have sufficient areas to filter a concentration of uniform small particles. Therefore the dirt holding capacity of these filters is very limited.

### SUMMARY OF THE INVENTION

The present invention relates to a pressure filter device having a series of stacked horizontal filter cells in a housing containing a liquid inlet and outlet. The housing has a top dome and bottom spherical end with internal ribs for supporting the cartridge. The cell is shaped like an inverted cup with the cup walls resting on the top of the next cell. The cell outside walls has a fluid inlet and porous septum at the bottom with fluid exiting to the center tube chamber containing a fluid outlet pipe and outside ribs to allow liquid to exit. The cells center pipe also allows the cells to be stacked and locked together during assembly. The cells contain various granular materials deposited in layers from fine to coarse. The cartridge assembly is inserted during assembly in the housing and guiding the tube end into a coupling and setting the cell assembly to rest on the ribs of the housing. The top dome is placed over the housing body and the top ribs are pressed into contact with the cells. Thus the outside top and bottom plates relieve the internal hydraulic forces. This construction allows the filter to operate intermittently without disturbing the placement of the granular media. The media is inserted in layers with the cell leg facing upward. Because of large surface area slower flow rates are achieved making it possible to use granular media down to 0.3 microns. Dirt holding capacity can also be greatly enhanced from depth filtration by a factor of 10:1. The filter housing and cell assembly are made of polymeric materials and are discarded after it is plugged.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a cutaway view of the cartridge assembly.

### DETAILED DESCRIPTION OF THE PREFERRED EMBODIMENTS

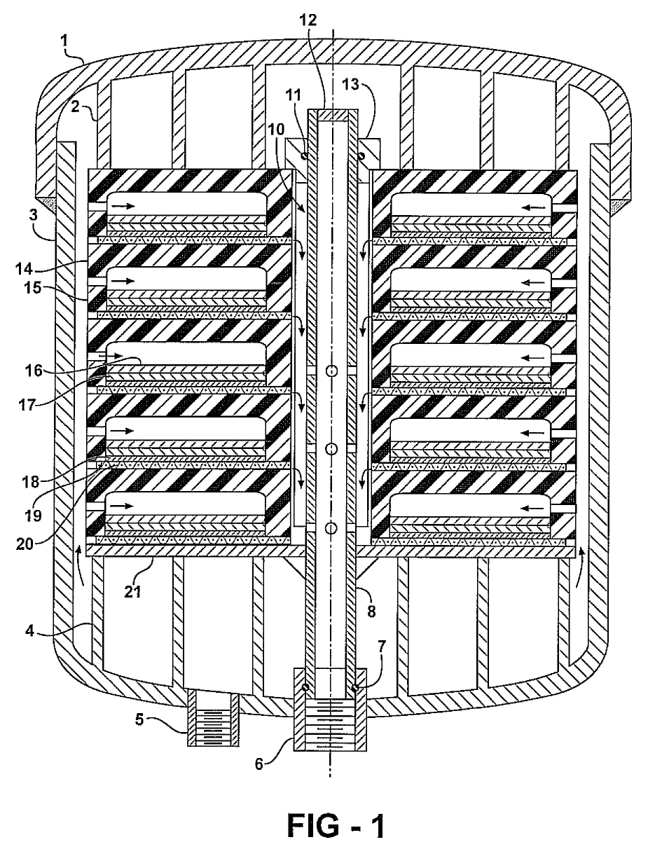

Referring to FIG. 1, the cartridge's polymer housing consists of a dome 1 with a bottom spherical end including internal supporting ribs 2 joined to a body 3 with plastic adhesives. The bottom inside the dome has additional ribs 4 for support from outward forces.

The base of the housing contains an inlet 5 and exhaust (coupling) 6. An inner fluid discharge tube 8 fits into the exhaust 6 and has a seal 7 and a series of liquid entry holes 9 in tube 8 which has at least three outside ribs to increase space for exiting liquids from the cells 14. Bushing 13 is affixed to the cell containing a seal 11 to prevent leakage. A plug 12 closes the top of tube 8.

Each of a plurality of cells, referenced at 14, contains a fluid inlet 15. The inside of the selected cell 14 contains first at the top coarse granular layer 16, next is a medium 17 layer and the final layer is 18. The layers 16-18 are arranged atop a septum 19 having a top perforate paper and a mesh bottom 20 which abuts against the inlet wall of the cell 14, discharges out of the cell 14 to a center annual space 10, and into the discharge tube 8 through the holes 9 and exit the filter at exhaust 6.

Having described my invention, other and additional preferred embodiments will become apparent to those skilled in the art to which is pertains, and without deviating from the scope of the appended claims.

I claim:

1. A disposable polymeric filter for processing liquids, comprising:
a housing with an inlet port and a outlet port, said housing including a top dome and a bottom dome, each of which including ribs to support a plurality of horizontally stacked filter cells having side wall aperture inlets and a bottom septum outlet composed of a mesh with a porous top sheet covering the lower end of the cell and supported by a top of an adjacent juxtaposition cell;
the interior space in the cell containing granular filter medias graded with a coarse top and decreasing in size to a fine grade base, a liquid being discharged to a central cavity larger than an internal drain pipe associated with the outlet and which is taper fit into a discharge coupling in the bottom of the housing.

2. The invention as described in claim 1, further comprising a discharge tube extending within said housing from the discharge coupling, “O” ring seals connecting to said tube at both ends of the housing.

3. The invention as described in claim 1, further comprising said filter media composed of various fibrous materials, sand, plastics strands and activated carbon.

4. A method of filtration of contaminated liquids using a depth filter with granular media arranged in layers and creating an optimum use of filter area, liquid flowing from coarse to fine layers.
